(19) United States
(12) Patent Application Publication
(10) Pub. No.: US 2011/0078021 A1
(43) Pub. Date: Mar. 31, 2011

(54) Mobile Device Including Mobile Application Coordinating External Data

(76) Inventor: John Tullis, San Francisco, CA (US)

(21) Appl. No.: 12/833,856

(22) Filed: Jul. 9, 2010

Related U.S. Application Data
(60) Provisional application No. 61/247,442, filed on Sep. 30, 2009.

(51) Int. Cl. G06F 17/30; G06Q 30/00; G06F 15/16

(52) U.S. Cl. 705/14.53; 707/705; 709/206; 707/E17.107

(57) ABSTRACT

Information stored on a consumer's mobile device can be used to produce recommendations for purchase of good/services. In embodiments, a consumer's purchase history can included in producing recommendations for purchase of good/services. Such recommendations can then be communicated to the consumer's mobile device.

### CROSS-REFERENCES TO RELATED APPLICATIONS

This application claims priority to U.S. Provisional Application No. 61/247,442, filed Sep. 30, 2009 and is fully incorporated herein by reference for all purposes. This application is related to a concurrently filed U.S. application, identified by attorney docket number 016222-055910US, entitled “MOBILE DEVICE INCLUDING MOBILE APPLICATION,” and is fully incorporated herein by reference for all purposes.

### BACKGROUND

A payment processing system (payment processors, payment processing network) facilitates the transactions between a merchant and consumers wanting to purchase goods or services from the merchant using a portable payment device such as a credit card or a debit card. Examples of payment processors include Visa, MasterCard, Discover, and the like. Portable payment devices (e.g., credit cards, mobile payment devices) are issued to consumers by an issuer (typically a financial institution such as a bank). The payment processing system mediates a communication (generally referred to as “authorization”) between the merchant's bank (acquirer) and the issuer when the consumer desires to make a purchase. The authorization is a means by which the issuer confirms to the merchant that the consumer has sufficient funds in an account with the issuer to make the purchase.

The purchase transaction that was initiated by the consumer generates information that is stored by the payment processor relating to specifics of the transaction, including time and place, identification of the goods, and so on. Over time, the payment processor can accumulate a history of transaction data regarding purchase habits of the consumer.

### BRIEF SUMMARY

In accordance with embodiments of the present invention, a computer software application (e.g., applet, moblet) can be provided on a consumer's mobile communication device or personal data device. In embodiments, the computer software application executing on the consumer's device may interact with data stored on such device. In embodiments, purchase transaction history information may be used. In embodiments, data maintained by a particular merchant may be used.

In accordance with embodiments of the present invention, the computer software application may perform an analysis of the data and make purchase recommendations with the merchant, or otherwise inform the consumer of purchase opportunities with the merchant. In embodiments, the computer software application may initiate such analysis to be performed on a computing system other than the consumer's device on which such computer software application is executing. For example, such other computer system may provide a recommendation engine to perform such analysis.

In embodiments, the computer software application may interact with data from multiple merchants, and make purchase recommendations or inform of purchase opportunities with these multiple merchants. In embodiments, recommendations and opportunities for purchase may be made for any merchant.

These and other embodiments of the present invention are disclosed.

### BRIEF DESCRIPTION OF THE DRAWINGS

FIG. 1 illustrates an embodiment of a system in accordance with the present invention.

FIG. 1A illustrates an embodiment of a system in accordance with the present invention.

FIG. 2 illustrates an embodiment of flow processing for purchase transaction history in accordance with the present invention.

FIG. 3 illustrates an embodiment of a consumer device in accordance with the present invention.

FIG. 4 illustrates a computer system that can be used to implement computer system embodiments of the present invention.

### DETAILED DESCRIPTION

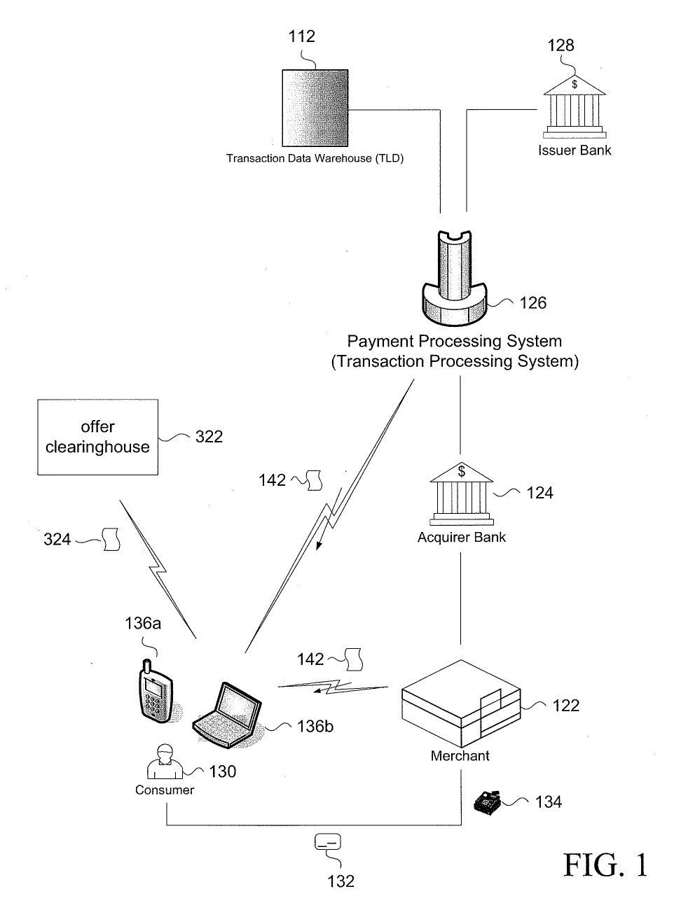

FIG. 1 shows an embodiment of a system in accordance with the present invention. There is a merchant 122 and an acquirer 124 associated with the merchant 122. The acquirer 124 can communicate with an issuer 128 via a payment processing system 126. In a typical purchase transaction, a consumer 130 may purchase goods or services at the merchant 122 using a portable consumer device 132. The consumer 130 may be an individual, or an organization such as a business that is capable of purchasing goods or services. The merchant can be a so-called brick and mortar establishment and/or an online entity conducting its business over the internet.

The portable consumer device 132 may be in any suitable form. For example, suitable portable consumer devices can be hand-held and compact so that they can fit into a consumer's wallet or pocket (e.g., pocket-sized). They may include smart cards, ordinary credit or debit cards (with a magnetic strip and without a microprocessor), keychain devices (such as the Speedpass™ device commercially available from Exxon-Mobil Corp.), and so on. Other examples of portable consumer devices include cellular phones, personal digital assistants (PDAs), pagers, payment cards, security cards, access cards, smart media, transponders, and the like. The portable consumer devices can also be debit devices (e.g., a debit card), credit devices (e.g., a credit card), or stored value devices (e.g., a stored value card).

The payment processing system 126 may include data processing subsystems, networks, and operations used to support and deliver authorization services, exception file services, and clearing and settlement services. A typical payment processing system may include VisaNet™. Payment processing systems such as VisaNet™ are able to process credit card transactions, debit card transactions, and other types of commercial transactions. VisaNet™, for example, includes a VIP system (Visa Integrated Payments system) to process authorization requests and an accounting system to perform conventionally known clearing and settlement services.

The payment processing system 126 may include a server computer. A server computer is typically a powerful computer or cluster of computers. For example, the server computer can be a large mainframe, a minicomputer cluster, or a group of servers functioning as a unit. In one example, the server computer may be a database server coupled to a Web server. The payment processing system 126 may use any suitable wired or wireless communication network, including the Internet. In an embodiment, the payment processing system 126 may include a transaction data warehouse 112.

Returning to the merchant 122, the merchant may have an access device 134 that can interact with the portable consumer device 132. The access device 134 according to embodiments of the invention can be in any suitable form. Examples of access devices include point of sale (POS) devices, cellular phones, PDAs, personal computers (PCs), tablet PCs, handheld specialized readers, set-top boxes, electronic cash registers (ECRs), automated teller machines (ATMs), virtual cash registers (VCRs), kiosks, security systems, access systems, and the like. If the merchant 122 is an online business, the access device 134 may simply be a communication device (e.g., modem) that is in communication with its acquirer 124.

If the access device 134 is a point of sale terminal, any suitable point of sale terminal may be used including card readers. The card readers may include any suitable contact or contactless mode of operation. For example, typical card readers can include RF (radio frequency) antennas, magnetic stripe readers, etc. to interact with the portable consumer devices 132.

In a typical purchase transaction, the consumer 130 may purchase a good or service at the merchant 122 using a portable consumer device 132 such as a credit card. The consumer's portable consumer device 132 can interact with an access device 134 such as a POS (point of sale) terminal at the merchant 122. For example, the consumer 130 may take a credit card and may swipe it through an appropriate slot in the POS terminal. Alternatively, the POS terminal may be a contactless reader, and the portable consumer device 132 may be a contactless device such as a contactless card.

An authorization request message can then be created and forwarded to the acquirer 124. After receiving the authorization request message, the authorization request message can then be sent to the payment processing system 126. The payment processing system 126 can then forward the authorization request message to the issuer 128 of the portable consumer device 132.

After the issuer 128 receives the authorization request message, the issuer 128 may send an authorization response message back to the payment processing system 126 to indicate whether or not the current transaction is authorized (or not authorized). The transaction processing system 126 may then forward the authorization response message back to the acquirer 124. The acquirer 124 may then send the response message back to the merchant 122.

After the merchant 122 receives the authorization response message, the access device 134 at the merchant's premises may then provide an authorization response message which can be displayed by the access device, or may be printed out on a receipt. The transaction may then conclude with successful purchase, or the transaction may be denied.

At the end of the day, a conventionally known clearing and settlement process can be conducted by the transaction processing system 126. A clearing process is a process of exchanging financial details between and acquirer 124 and an issuer 128 to facilitate posting to a consumer's account and reconciliation of the consumer's settlement position.

In embodiments of the present invention, one or more mobile applications 142 can be provided to the consumer; for example, to their various mobile devices 136a, 136b such as cell phones, PDAs and so on. In embodiments, the computer software application 142 may be provided by a merchant 122 from which the consumer 130 has made previous purchases. In embodiments, the payment processing system 126 may provide a mobile application 142 to the consumer's mobile device 136a/136b (e.g., cellular telephone 136a, or laptop computer 136b). See for example, concurrently filed U.S. application, identified by attorney docket number 016222-055910US, entitled “MOBILE DEVICE INCLUDING MOBILE APPLICATION.” In embodiments, the computer software application 142 may be provided by a third party entity other than merchants 122 or the payment processing system 126.

Computer software applications 142 may comprise any suitable code that can be executed by the consumer's mobile device 136a, 136b. In embodiments, a computer software application 142 may be computer executable instructions that are executed by a data processing subsystem (e.g., one or more CPU's—central processing unit) comprising the mobile device 136a, 136b. In embodiments, a computer software application 142 may comprise interpreted instructions such as Java® bytecode.

In embodiments, the computer software application 142 can be “pushed” to the consumer's device, which may require prior permission from the consumer. In an embodiment, the application can be segmented and pushed in a series of SMS messages and then reconstructed on the receiving device. In an embodiment, the consumer may be informed that one or more computer software applications are available. For example, the consumer 130 may receive a text message informing them of the availability of one or more computer software applications that are available for downloading. The text message could include a link. The consumer 130 could receive such a notification in an email, and so on. The consumer 130 can then send a suitable acknowledgement indicating that they accept the computer software application 142 that is being offered.

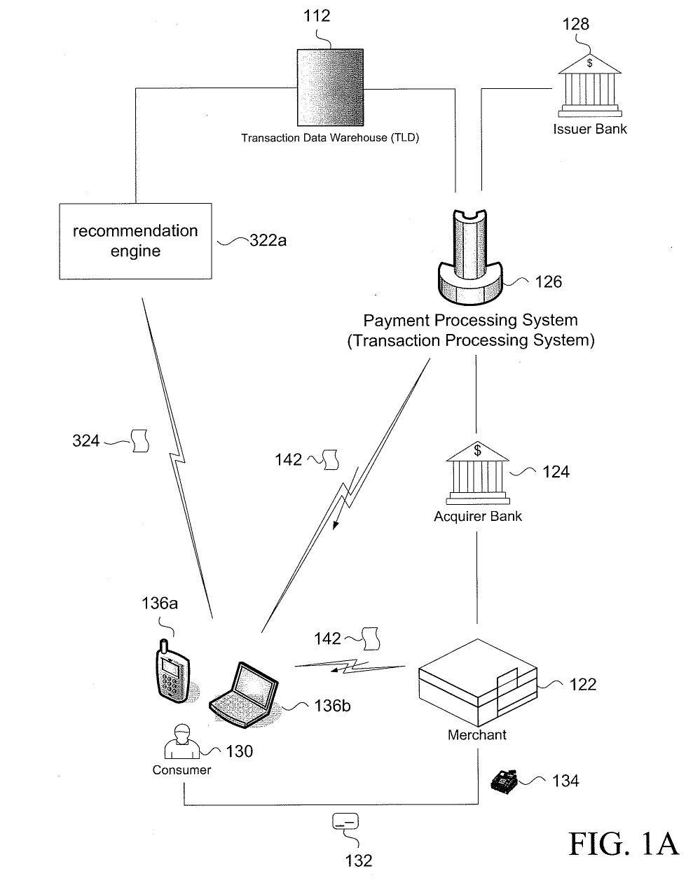

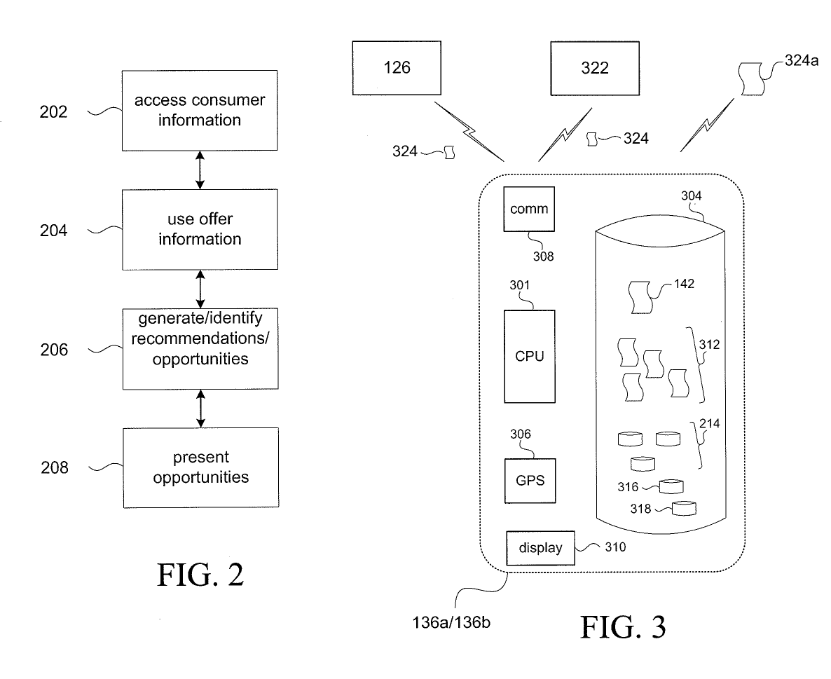

Refer now to FIGS. 2 and 3 for a discussion of processing by the computer software application 142 in accordance with embodiments of the present invention. In an embodiment, the computer software application may be stored on a consumer's device 136a/136b. FIG. 3 illustrates a block diagram of an embodiment of a consumer's device 136a/136b. Components may include, among other elements, a data processing component 302, a memory subsystem 304 (which may comprise various forms of memory devices such as flash memory, read-only memory, and so on), a GPS (global positioning system) chip 306, and a communication module 308.

The computer software application 142, which can be stored in the memory subsystem 304, may execute on the consumers' device 136a/136b, and by so doing cause the data processing component 302 to perform various steps. In a step 202, the computer software application 142 can access information 312-318 that is contained on the consumer's device 136a/136b; for example, in the memory subsystem 304. Such information can be used to determine certain interests of the consumer 130 in order to identify opportunities that can be offered to the consumer, as will be explained in further detail below. Such information, collectively referred to herein as “consumer information”, can exist in any of a number of ways. The consumer information may be extracted from, derived from, or other based on the information 312-318 that is contained on the consumer's device 136a/136b. A non-exhaustive description of examples of such information 312-318 follows.

In embodiments, consumer information may include information 314 that is created, managed, and stored by various applications 312. For example, a calendar application can maintain appointments and other scheduling information, an email application can maintain emails and attachments, a text messaging application may maintain text messages stored on the consumer's device. Such information 314 may include to-do lists, memos, and so on that can be generated and stored by suitable applications 312. Such information 314 may include messages sent and received using social networking applications such as Twitter, Facebook, Linkedln and the like.

In embodiments, consumer information may include purchase history information 316 about previous purchases made by the consumer 130. For example, a brief summary of each purchase transaction can be stored on the consumer's device 136a/136b. In an embodiment, the computer software application 142 may access the payment processing system 126 to obtain a summary of prior purchase transactions. For example, the payment processing system 126 may store information about purchases made by consumers in a transaction data warehouse 112. Summaries, and the like, of information stored in the transaction data warehouse 112 may be stored on the consumer's device 136a/136b. The prior purchase transactions may be for a given period of time, for a given category of merchandise (including internet merchants and so-called brick & mortar merchants), for a given type of merchants, for merchant in a geographic area, for a given merchant, and so on.

In embodiments, consumer information may include information about the kinds of applications 312 that are stored on the consumer's device 136a/136b. For example, if the consumer 130 is interested in travel, they may have various applications relating to travel. If the consumer 130 is interested in wines, they may have various applications relating to wines. Information about the different kinds of applications stored on the consumer's device 136a/136b may be useful in identifying a consumer's interests. In an embodiment, the names of the application 312 may be used to determine what kind of application it is. In an embodiment, the application 312 may have associated metadata that provides, among other things, information about what kind of application it is.

In embodiments, consumer information may include geographic location information 318, for example, obtained by a GPS (global positioning system) application that is executing on the consumer's device 136a/136b. The geographic location information can indicate the consumer's current location. The geographic location information may be accumulated over a period of time, which may for example be used to identify places (such as stores, restaurants, etc.) that the consumer 130 had visited over a period of time.

Such consumer information is generally regarded as personal and confidential, and thus computer software applications 142 in accordance with the present invention may very well incorporate strict and secure privacy measures. For example, in embodiments, the computer software application 142 may be configurable by the consumer 130 to control access to such information.

Continuing with the description of FIG. 2, the computer software application 142 may receive offer information 324 from an offer clearinghouse 322 (step 204). The offer clearinghouse 322 may include a storage system that serve as a warehouse or repository of offers. The offer clearinghouse 322 may comprise a computer system for communicating with the computer software application 142 that is executing on the consumer's device 136a/136b. It will be appreciated that in embodiments of the present invention, the offer clearinghouse 322 may be a merchant 122, or may be a group of merchants, or may be a third party service acting on behalf of one or more merchants, or may be a special interest group (e.g., a nature conservancy group) that is not connected with any specific merchant, and so on. As can be appreciated, the offer clearinghouse 322 can be any kind of entity that serves to collect and manage offers.

As illustrated in FIG. 1A, in an embodiment, the offer clearinghouse may be part of or otherwise affiliated with the payment processing system 126. For example, in such an embodiment a recommendation engine 322a may be provided. The recommendation engine 322a may be in communication with the transaction data warehouse 112. For clarity, it will be understood that references to “offer clearinghouse 322” will generally be understood to include offer clearinghouse 322 (FIG. 1) or recommendation engine 322a (FIG. 1A).

Returning to FIG. 2, the step 204 may include the computer software application 142 making a determination based on the consumer information 312-318 that the consumer 130 may be interested in opportunities that the offer clearinghouse 322 may have to offer. The computer software application 142 may then obtain offer information 324 from the offer clearinghouse 322 that is relevant to such interest(s). In a step 206, the consumer information 312-318 and the received offer information 324 can be analyzed to identify if an opportunity for goods or services exists.

In a step 208, any identified opportunities for goods or services can be presented to the consumer 130 as one or more offers or recommendations 324a. Such offers or recommendations 324a can be any information that might be deemed useful to the consumer 130. Offers or recommendations 324a can be advertisements, can be related to sales opportunities (such as sale of goods or services), can be announcements, can be purely informational in nature, and so on. In an embodiment, the computer software application 143 may display an alert message on the consumer's device 136a/136b. In an embodiment, the computer software application 142 may send a request to the offer clearinghouse 322 to communicate the offers or recommendations 324a to the consumer's device 126a/136b. The offers or recommendations 324a can be texted to the consumer. The offers or recommendations 324a can be emailed to the consumer 130. The offer clearinghouse 322 may communicate with the consumer 130 by calling the consumer using a live operator or an automated operator.

In the foregoing embodiments, steps 204 and 206 may be performed by the computer software application 142 executing on the consumer's device 136/a/136b. In other embodiments, step 204 may include sending at least portions of the consumer information 312-318 to the offer clearinghouse 322. Step 206 may be performed by computers at the offer clearinghouse 322 to generate/identify one or more opportunities for goods or services that may be of interest to the consumer 130 using the received consumer information 312-318. In an embodiment, where the offer clearinghouse is the recommendation engine 322a, the step 206 may further include accessing and using the consumer's purchase history information stored in the transaction data warehouse 112 to generate/identify one or more opportunities for goods or services for the consumer 130.

Given the privacy concerns of the consumer information 312-318 as explained above, such generated information may be encrypted before being sent to the offer clearinghouse 322. Suitable secured communications (e.g., secured sockets layer protocols, SSL) may be employed to communicate such generated information to the offer clearinghouse 322. In embodiments, there may be additional requirements to obtain permission from the consumer to allow for such communications to take place, stemming from applicable regulatory laws, privacy policies of the offer clearinghouse 322, and the like.

Examples of the foregoing process may facilitate a further appreciation of embodiments of the present invention. Accordingly, the discussion will now turn to the following sample, but by no means an exhaustive list, of examples to illustrate aspects of the present invention.

In an embodiment, for example, suppose a computer software application 142 is sponsored by a group of local theatre operators. The computer software application 142 may access the consumer information 312-318 that is stored on the consumer's device. Step 202. For example, the consumer's date book might be reviewed to reveal that the consumer is available on Friday evening. Prior theatre purchases (either already stored on the consumer's device 136a/136b or accessed from the payment processing system 126) may be used by the computer software application 142 to determine that the consumer 130 often attends the theatre. Such a determination can then be used to make a request from the offer clearinghouse 322 (e.g., a server managed by the group of local theatre operators) to provide relevant offers. Steps 204/26. For example, offers for tickets for an upcoming performance may provided to the consumer 130. Step 208. Instead of, or in addition, information about the performers may be provided to the consumer 130.

In an embodiment, for example, suppose a computer software application 142 is provided by a grocery store chain. The computer software application 142 may access the consumer information 312-318. Step 202. For example, the consumer's date book might be reviewed to reveal that it is time for the consumer to do their weekly grocery shopping. The GPS chip 306 may indicate that the consumer 130 is nearby one of the grocery chain's stores. This set of circumstances may cause the computer software application 142 to send a request to the offer clearinghouse 322 (e.g., in this embodiment, the offer clearinghouse may be a web service managed by the grocery store chain) to obtain a list of specials being offered by the store that the consumer 130 happens to be in the vicinity of. Step 204/206. The consumer 130 may be alerted of such specials by way of a text message that is sent to the consumer's device 136a/136b. Step 208.

In an embodiment, for example, a computer software application 142 may be a travel planning application developed and distributed by the payment processing system 126 as a value-added application for its customers. In this embodiment, the recommendation engine 322a may be in communication with a reservation network, such as the Sabre Travel Network. The computer software application 142 may detect that various travel-related applications are stored on the consumer's device 136a/136b. Step 202. The computer software application 142 may interact with the recommendation engine 322a (step 204), which may then identify travel-related opportunities on the reservation network such as airline seating availabilities, hotel room availability, and so on. The computer software application 142 may then receive such offers from the recommendation engine 322a and present them to the consumer 130.

In an embodiment, for example, a payment processing system 126, such as Visa may provide a “Visa-Centric 1-Click Purchase” computer software application 142 for execution on a cell phone. A Visa cardholder, whose card history reflects frequent purchases of a particular item can start the computer software application 142 installed on their cell phone. The computer software application can collaborate with the cell phone's GPS capabilities to locate nearby merchants determined, via web-access for example, to have available inventory of the particular item. For each match, a 1-click ‘card-not-present’ transaction authorization and purchase can be made by the computer software application 142. The user experience for this mobile transaction is that the cardholder can then proceed to pick up the pre-purchased inventory from the merchant who is holding it.

In an embodiment of the invention, a “Favorite Dining Reservation” computer software application 142 may be provided. A Visa card holder whose card statement reflects frequent dinning at French Restaurants may start the computer software application on their cell phone. The computer software application can collaborate with the cell phone's GPS capabilities to locate nearby French Restaurants that have available tables in a time frame matching that of the user's MS Outlook Calendar, online Google Calendar, or other web-accessible calendaring database. The computer software application can also match the cardholder's previously stored preferences for wine and menu items with the web-accessible inventory of nearby French Restaurants. If all of the cardholder's preferences are matched to that of a nearby French Restaurant, a reservation can be made with that restaurant using the cardholder's Visa card. A reservation notification can then be sent to the restaurant as to the cardholder's desired wine and menu item choices as a demand upon the restaurant's available inventory, and the cardholder receives confirmation of the reservation date and time.

In an embodiment of the invention, a “Visa-Centric Data Supplier” computer software application may be provided. When the computer software application is executed, the cardholder's prior transaction history is made available to other applications on the cell phone. For example, the user may use a browser to query a mobile version of Google maps, Google Shopping, Amazon, eBay, or another popular e-commerce web site. When prompted by the e-commerce application, the In an embodiment of the invention, can activate the cell phone application that supplies access to the user's payment card purchase history to the e-commerce application. For example, the cell phone application can permit Amazon.com to access to the user's Visa card purchase history to identity a past purchase from a merchant in order to find out what price that merchant is now offering for the same item, or to find out whether the cardholder has ever made any purchase from any merchant located in the area matching the cell phone's GPS coordinates.

In an embodiment of the invention, a “Book My Trip” computer software application 142 may be provided. The user may activate the computer software application 142 to permit Expedia.com, for example, to access past card purchases during a particular past time frame in order to book hotel and restaurants for a future vacation or business trip that is specified in the cardholder's web-assessable calendar. The computer software application 142 can off-load to Visa, or its agent, a ‘curve fitting’ algorithm of available reservations based upon the cardholder's travel and entertainment card purchase history to assess future available inventory of goods and services, reservations, as well as calculated travel times between merchants. The curve fitting algorithm may summarize goods and services quotations so as to fall within a predetermined budget. For a set of matching reservations that have ‘fit the curve’, reservations for the future trip can then be made with the cardholder's payment card.

In an embodiment of the invention, a “What Did I Forget To Buy” computer software application 142 may be provided. When a cardholder is making, or is in the process of making, a purchase at a merchant with whom the cardholder has made a past purchase, the cardholder can execute a Visa-centric the computer software application 142. In response to the cardholder being prompted with a list of merchants proximal the cell phone's GPS coordinates with whom Visa found a match with a past card purchase, a list of the cardholder's prior purchase(s) at the matching merchant can be returned and presented on the cell phone's display for the user's review. The cardholder can thus be reminded about a past purchase transaction at the user.

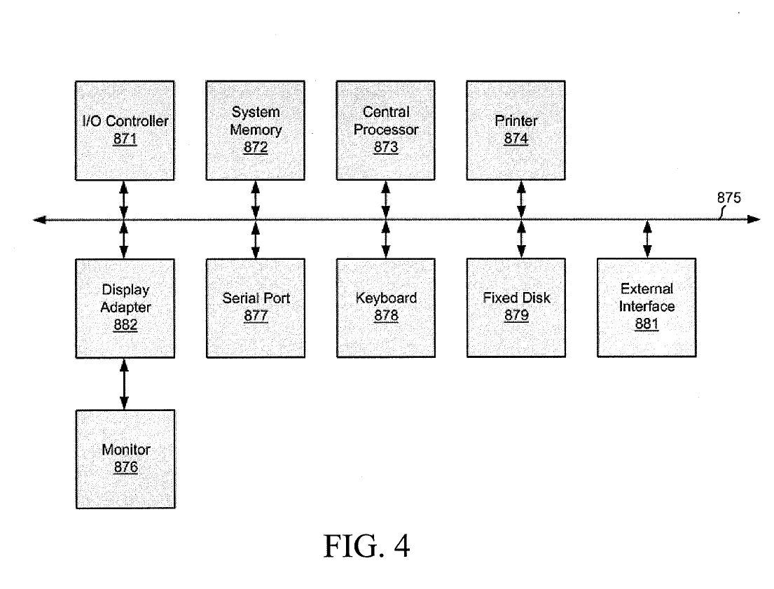

Any of the entities or components described above may include one or more of the subsystems or components shown in FIG. 4, which is a block diagram of a computer apparatus. The subsystems shown in the figure are interconnected via a system bus 875. Additional subsystems such as a printer 874, keyboard 878, fixed disk 879, monitor 876, which is coupled to display adapter 882, and others are shown. Peripherals and input/output (I/O) devices, which couple to I/O controller 871, can be connected to the computer system by any number of means known in the art, such as serial port 877. For example, serial port 877 or external interface 881 can be used to connect the computer apparatus to a wide area network such as the Internet, a mouse input device, or a scanner. The interconnection via system bus allows the central processor 873 to communicate with each subsystem and to control the execution of instructions from system memory 872 or the fixed disk 879, as well as the exchange of information between subsystems. The system memory 872 and/or the fixed disk 879 may embody a computer readable medium.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

In embodiments of the present invention, the purchase history of a consumer (e.g., purchase behavior and patterns) can be determined based on purchase transaction information generated from the consumer's purchases. The information can be used to further enhance relationships among consumers, merchants, and financial institutions such as the issuer. Merchants and financial institutions may benefit from tailored one-to-one relationships with their customers to foster enhanced cardholder retention and usage. With the appropriate customer permissions the payment processor, a financial institution, or an affinity partner can create tailored loyalty applications that may be delivered to a customer's phone, PC, or other IP connected electronic device to stimulate dialogue intended to enhance consumer.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A method of operating a mobile device of a consumer comprising:
the mobile device accessing consumer information based on information on the mobile device;
the mobile device storing produced information that is based at least on the consumer information and on purchase history information relating to prior purchases made by the consumer; and
the mobile device presenting the produced information to the consumer.

2. The method of claim 1 further comprising the mobile device receiving offer information from an offer clearinghouse, wherein the step of storing comprises generating information based on the consumer information, the purchase history information, and the offer information.

3. The method of claim 2 further comprising the mobile device receiving the purchase history information from a data source other than the mobile device.

4. The method of claim 1 further comprising the mobile device sending the consumer information and the purchase history information to a data processor other than the mobile device, wherein the step of storing comprises receiving from the data processor the produced information and storing the produced information in a memory of the mobile device, wherein the data processor generates the produced information.

5. The method of claim 1 wherein the consumer information comprises data produced by applications stored on the mobile device, or information associated with the applications stored on the mobile device, or purchase transaction history of the consumer.

6. The method of claim 1 wherein the presenting includes the mobile device receiving a text message or the mobile device receiving an email or the mobile device generating a message that is displayed thereon.

7. The method of claim 1 wherein the produced information comprises offers for sale of goods or services, or announcements, or general information.

8. A method of operating a mobile communication device of a consumer comprising the mobile communication device performing steps of:
accessing consumer information comprising information that is stored on the mobile communication device;
obtaining one or more messages relating to purchasing opportunities based at least on the consumer information and on offer information, the offer information being stored in a data center other than the mobile communication device; and
displaying on a display component of the mobile communication device the one or more messages.

9. The method of claim 8 further comprising accessing data stored at a payment processing center, wherein the one or more messages are further based on the data accessed.

10. The method of claim 9 wherein the data stored at the payment processing center comprises information about prior purchases made by the consumer.

11. The method of claim 8 further comprising receiving the offer information from the data center, wherein the step of obtaining includes the mobile communication device generating the one or more messages based on the consumer information and on the offer information.

12. The method of claim 8 further comprising sending the consumer information to the data center, wherein the step of obtaining one or more messages includes receiving the one or more messages from the data center, wherein the one or more messages are generated at the data center.

13. The method of claim 12 further comprising receiving a text message indicative of the one or more messages or receiving an email indicative of the one or more messages or generating a message indicative of the one or more messages.

14. The method of claim 8 wherein the consumer information comprises data produced by applications stored on the mobile device, or information associated with the applications stored on the mobile device, or purchase transaction history of the consumer.

15. The method of claim 8 wherein the produced information comprises offers for sale of goods or services, or announcements, or general information.

16. Computer software application stored on a mobile device and comprising a plurality of computer program instructions configured to cause a data processor of the mobile device to perform steps of:
accessing consumer information comprising information that is stored on the mobile device;
obtaining one or more messages relating to purchasing opportunities based at least on the consumer information and on offer information, the offer information being stored in a data center other than the mobile device; and
displaying on a display component of the mobile device the one or more messages.

17. The computer software application of claim 16 wherein the information stored on the mobile communication device comprises data produced by applications stored on the mobile communication device, or information associated with the applications stored on the mobile communication device, or purchase transaction history of a consumer.

18. The computer software application of claim 16 wherein the computer program instructions further cause the data processor to perform steps of receiving the offer information from the data center, wherein the step of obtaining includes the mobile communication device generating the one or more messages based on the consumer information and on the offer information.

19. The computer software application of claim 16 wherein the computer program instructions further cause the data processor to perform steps of sending the consumer information to the data center, wherein the step of obtaining one or more messages includes receiving the one or more messages from the data center, wherein the one or more messages are generated at the data center.

20. The computer software application of claim 16 wherein the computer program instructions further cause the data processor to perform steps of receiving a text message or receiving an email indicative of the one or more messages.
